(19) United States
(12) Patent Application Publication
(10) Pub. No.: US 2024/0168344 A1
(43) Pub. Date: May 23, 2024

(54) HEAD-MOUNTED DISPLAY DEVICES WITH REDUCED WIRELESS INTERFERENCE BY OPTOELECTRONIC COMPONENTS

(71) Applicant: Meta Platforms Technologies, LLC, Menlo Park, CA (US)

(72) Inventors: Francis Lawrence Leard, Sudbury, MA (US); Javier Rodriguez De Luis, Kirkland, WA (US); Afsoon Jamali, Issaquah, WA (US); Olga Vladimirovna Barykina-Tassa, San Mateo, CA (US)

(21) Appl. No.: 18/518,529

(22) Filed: Nov. 23, 2023

Related U.S. Application Data
(60) Provisional application No. 63/427,820, filed on Nov. 23, 2022.

(51) Int. Cl. G02F 1/1343; G02F 1/155

(52) U.S. Cl. CPC G02F 1/13439; G02F 1/155; G02F 1/134309; G02F 2202/06

(57) ABSTRACT

An electronic device includes one or more antennas and one or more optoelectronic components. The one or more optoelectronic components include one or more electrodes. The one or more electrodes have a specified sheet resistance. The one or more electrodes may include aluminum doped zinc oxide, sub-wavelength-roughened electrodes, nano-imprinted electrodes, electroplated electrodes, indium tin oxide or one or more boundary layers. The one or more boundary layers may include one or more layers of indium molybdenum oxide and/or one or more layers of indium niobium oxide. The one or more electrodes may be aligned via field-induced alignment. The one or more antennas may be positioned in a first layer of the electronic device and the one or more optoelectronic components may be positioned in a second layer of the electronic device distinct from the first layer. The electronic device may be used in a head-mounted display device.

### RELATED APPLICATIONS

This application claims the benefit of, and priority to, U.S. Provisional Patent Application Ser. No. 63/427,820, entitled “AR/VR Headsets With Reduced Wireless Interference By Optoelectronic Components” filed Nov. 23, 2022, which is incorporated by reference herein in its entirety.

### TECHNICAL FIELD

The present disclosure relates generally to head-mounted display devices with optoelectronic components and, more specifically, to configurations of optoelectronic components and antennas in head-mounted display devices.

### BACKGROUND

Optoelectronic components are widely used in optical applications. By providing the ability to modulate light based on applied electrical signals, optoelectronic components can be used, for example, to switch on or off transmission of light. In portable electronic devices, optoelectronic components are conventionally placed adjacent to an antenna used for sending and/or receiving wireless signals.

### SUMMARY

Placing the optoelectronic components adjacent to the antenna can attenuate or interfere with the wireless signals emitted and/or received by the antenna. This attenuation or interference can reduce antenna efficiency.

This application describes electronic devices in which optoelectronic components are configured to reduce wireless interference. The disclosed devices may reduce the wireless interference without negatively impacting the performance (e.g., switching speed between “on” and “off” states) of the optoelectronic components.

In accordance with some embodiments, an electronic device includes one or more antennas and one or more optoelectronic components. The one or more optoelectronic components include one or more electrodes. The one or more electrodes have a specified sheet resistance.

In some embodiments, the one or more electrodes include aluminum doped zinc oxide.

In some embodiments, the one or more electrodes include sub-wavelength-roughened electrodes.

In some embodiments, the one or more electrodes include nano-imprinted electrodes.

In some embodiments, the one or more electrodes include electroplated electrodes.

In some embodiments, the one or more electrodes are aligned via field-induced alignment.

In some embodiments, the one or more electrodes include one or more boundary layers.

In some embodiments, the one or more boundary layers include one or more layers of indium molybdenum oxide.

In some embodiments, the one or more boundary layers include one or more layers of indium niobium oxide.

In some embodiments, the one or more antennas are positioned at a predetermined position relative to the one or more optoelectronic components.

In some embodiments, the one or more antennas are positioned in a first layer of the electronic device. The one or more optoelectronic components are positioned in a second layer of the electronic device. The second layer of the electronic device is distinct from the first layer of the electronic device.

In some embodiments, the one or more electrodes include indium tin oxide.

In some embodiments, the indium tin oxide of the one or more electrodes is trimmed to create a gradual tint of the one or more optoelectronic components.

In some embodiments, a head-mounted display device includes an electronic device and a display. The electronic device includes one or more antennas and one or more optoelectronic components. The one or more optoelectronic components include one or more electrodes having a specified sheet resistance. The display is optically coupled with the electronic device.

The disclosed electronic devices may replace conventional electronic devices that include optoelectronic components. The disclosed electronic devices may complement conventional electronic devices that include optoelectronic components.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a schematic diagram illustrating an electronic device in accordance with some embodiments.

FIG. 2 is a schematic diagram illustrating an electrode having one or more boundary layers in accordance with some embodiments.

FIG. 3 is a schematic diagram illustrating an electrode aligned via field induced alignment in accordance with some embodiments.

FIG. 4 is a schematic diagram illustrating an optoelectronic component with a gradual tint in accordance with some embodiments.

FIGS. 5A and 5B are schematic diagrams illustrating relative orientations of an electrode and an antenna in accordance with some embodiments.

FIGS. 6A and 6B are schematic diagrams illustrating the relative positions of an electrode and an antenna in accordance with some embodiments.

FIGS. 7A and 7B are schematic diagrams illustrating the relative positions of an optoelectronic component and an antenna relative to a head-mounted display device in accordance with some embodiments.

These figures are not drawn to scale unless indicated otherwise.

### DETAILED DESCRIPTION

As described above, conventional optoelectronic components are often placed adjacent to an antenna and therefore reduce and/or interfere with the wireless signals emitted and/or received by the antenna. The electronic devices described herein reduce the wireless interference caused by the optoelectronic components.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

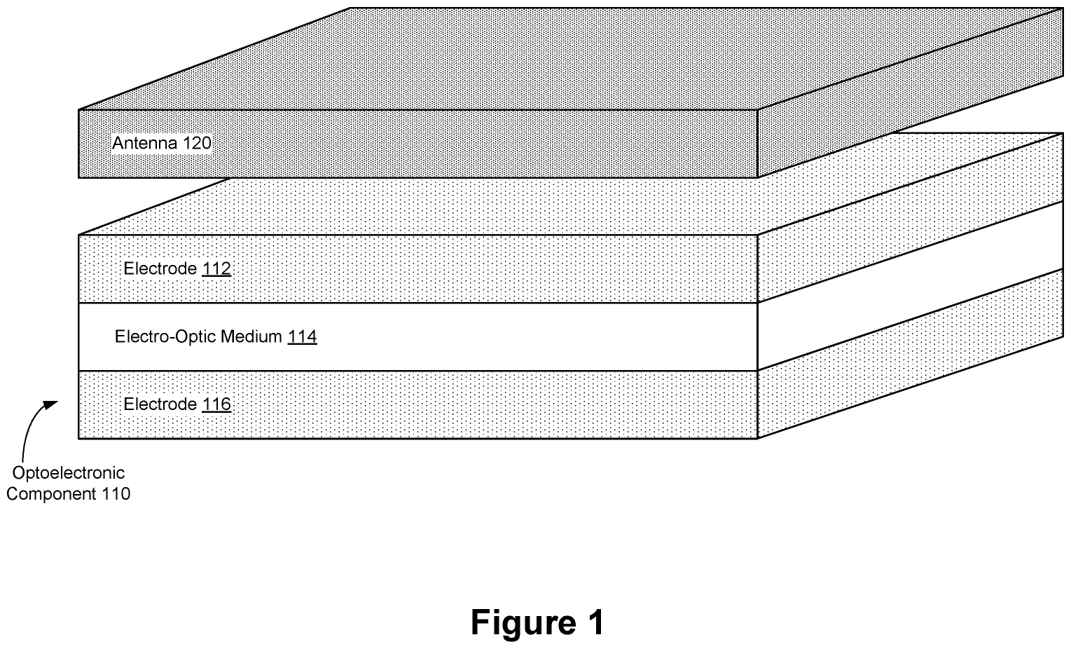

FIG. 1 is a schematic diagram illustrating an electronic device in accordance with some embodiments. In FIG. 1, the electronic device includes an optoelectronic component 110 and an antenna 120. In some embodiments, as shown in FIG. 1, the optoelectronic component 110 includes one or more electrodes (e.g., electrode 112 and/or electrode 116). In some embodiments, the optoelectronic component 110 includes electro-optic medium 114 (e.g., liquid crystals). In some embodiments, the electro-optic medium 114 is located between two electrodes (e.g., electrode 112 and electrode 116).

At least one electrode of the one or more electrodes (e.g., the electrode 112) has a specified sheet resistance (e.g., the electrode 112 is characterized by the specified sheet resistance).

In some embodiments, the sheet resistance refers to a resistance of a square portion of a thin material. In some cases, the sheet resistance Rₛ is calculated by:

Rₛ=ρ/t

where ρ is material resistivity of the thin material and t is a thickness of the thin material.

In some embodiments, the one or more electrodes include one or more transparent conductive electrodes. In at least some configurations of the optoelectronic component, electronic device, and/or a head-mounted display device, the transparent conductive electrodes allow the user to see the physical world through the transparent conductive electrode. For example, the one or more electrodes may include a transparent conductive electrode containing indium tin oxide (ITO).

In some embodiments, the one or more electrodes include micro- and/or nano-structures. The micro- and/or nano-structures may increase the sheet resistance of the one or more electrodes. In certain configurations, increasing the sheet resistance of the one or more electrodes reduces losses in the antenna efficiency. For example, increasing the sheet resistance of the electrodes may reduce interference with wireless signals emitted and/or received by the antenna.

In some embodiments, the one or more electrodes include sub-wavelength roughened electrodes. The sub-wavelength roughened electrodes may increase the sheet resistance of the one or more electrodes (e.g., an electrode with sub-wavelength roughened features may have a higher sheet resistance than an electrode without sub-wavelength roughened features). As explained above, in certain configurations, increasing the sheet resistance of the one or more electrodes reduces losses in the antenna efficiency. For example, increasing the sheet resistance of the one or more electrodes may reduce interference with wireless signals emitted and/or received by the antenna. The sub-wavelength roughening may be performed before coating the one or more electrodes with a transparent conductive material (e.g., transparent conductive oxide). The layer of transparent conductive material may operate as a wide angle and/or wide wavelength anti-reflection coating. The layer of the transparent conductive material may be formed in connection with a stack of dielectric-metal-dielectric materials.

In some embodiments, the one or more electrodes include nano-imprinted electrodes. The nano imprinting may be performed via lithography. Nano imprinting the electrodes may increase the sheet resistance of the one or more electrodes. Increasing the sheet resistance of the one or more electrodes may reduce losses in the antenna efficiency. For example, increasing the sheet resistance of the one or more electrodes may reduce interference with wireless signals emitted and/or received by the antenna. The imprinting may be performed before coating the one or more electrodes with a transparent conductive material (e.g., transparent conductive oxide). The layer of transparent conductive material may operate as a wide angle and/or wide wavelength anti-reflection coating. The layer of the transparent conductive material may be formed in connection with a stack of dielectric-metal-dielectric materials.

In some embodiments, the one or more electrodes include aluminum doped zinc oxide. The aluminum doped zinc oxide may increase the sheet resistance of the electrodes. Increasing the sheet resistance of the one or more electrodes may reduce losses in the antenna efficiency. For example, increasing the sheet resistance of the one or more electrodes may reduce interference with wireless signals emitted and/or received by the antenna.

In some embodiments, the one or more electrodes include electroplated electrodes. The electroplating can increase the sheet resistance of the electrodes. Increasing the sheet resistance of the one or more electrodes may reduce losses in the antenna efficiency. For example, increasing the sheet resistance of the one or more electrodes may reduce interference with wireless signals emitted and/or received by the antenna.

In some embodiments, the one or more electrodes has a sheet resistance that satisfies a sheet resistance threshold. The sheet resistance threshold may be based on an amount of wireless interference from the one or more optoelectronic components satisfying a wireless interference threshold. The amount of wireless interference may be measured at the one or more antennas. For example, the sheet resistance threshold is based on the wireless interference at the one or more optoelectronic components being less than the wireless interference threshold.

In some embodiments, the sheet resistance of an electrode is equal to or greater than 200 ohm/sq. 300 ohm/sq. 400 ohm/sq. 500 ohm/sq, 600 ohm/sq. 700 ohm/sq, 800 ohm/sq, 900 ohm/sq. 1000 ohm/sq. 1100 ohm/sq. 1200 ohm/sq. 1300 ohm/sq. 1400 ohm/sq, 1500 ohm/sq. 1600 ohm/sq. 1700 ohm/sq. 1800 ohm/sq. 1900 ohm/sq, 2000 ohm/sq. 2100 ohm/sq. 2200 ohm/sq. 2300 ohm/sq. 2400 ohm/sq. 2500 ohm/sq. 2600 ohm/sq. 2700 ohm/sq, 2800 ohm/sq. 2900 ohm/sq. 3000 ohm/sq. 3100 ohm/sq. 3200 ohm/sq. 3300 ohm/sq, 3400 ohm/sq, 3500 ohm/sq. 3600 ohm/sq. 3700 ohm/sq. 3800 ohm/sq. 3900 ohm/sq, or 4000 ohm/sq, or is within an interval between any two aforementioned values.

In some embodiments, increasing the sheet resistance of the one or more electrodes reduces the wireless interference between the one or more antennas and the one or more optoelectronic components. In some embodiments, increasing the sheet resistance of the one or more electrodes reduces loss in efficiency of the one or more antennas. In some embodiments, the sheet resistance of the one or more electrodes is achieved by reducing the thickness of the one or more electrodes.

In general, increasing a resistance in a resistor-capacitor (RC) circuit may affect the performance of the RC circuit. For example, an optoelectronic component may be modeled as an RC circuit. Thus, increasing the sheet resistance of the electrode may affect the performance of the optoelectronic component. However, the performance of the optoelectronic component will not change significantly if a RC time constant is less than the driving frequency of the optoelectronic component. For example, in applications with a driving frequency between 10 and 20 ms, the sheet resistance can be increased substantially without substantially changing the switching speed of the optoelectronic component.

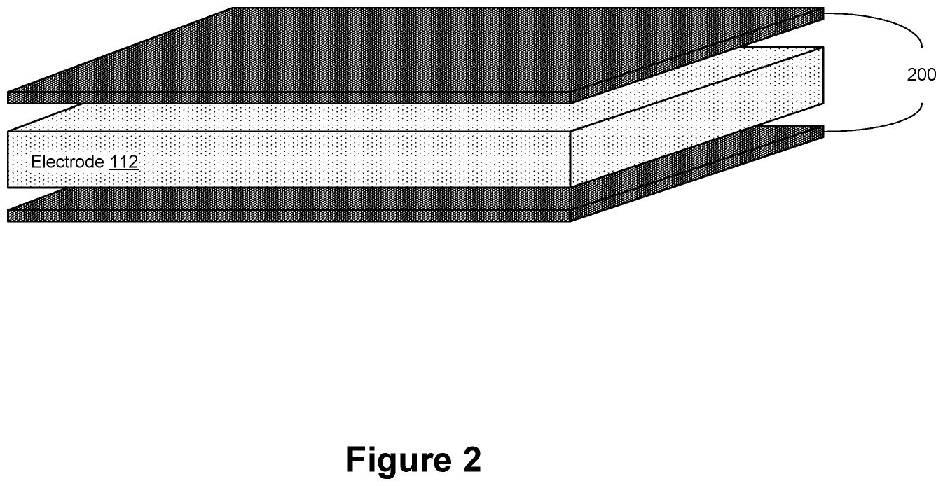

FIG. 2 is a schematic diagram illustrating an electrode 112 having one or more boundary layers 200 in accordance with some embodiments.

In some embodiments, the one or more boundary layers 200 of the one or more electrodes may isolate the magnetic coupling effect between the one or more optoelectronic components and the one or more antennas. For example, the one or more boundary layers 200 may attenuate the strength of the electromagnetic fields generated at the one or more optoelectronic components and thereby reducing the wireless interference experienced at the one or more antennas.

In some embodiments, the one or more boundary layers 200 include indium molybdenum oxide and/or indium niobium oxide.

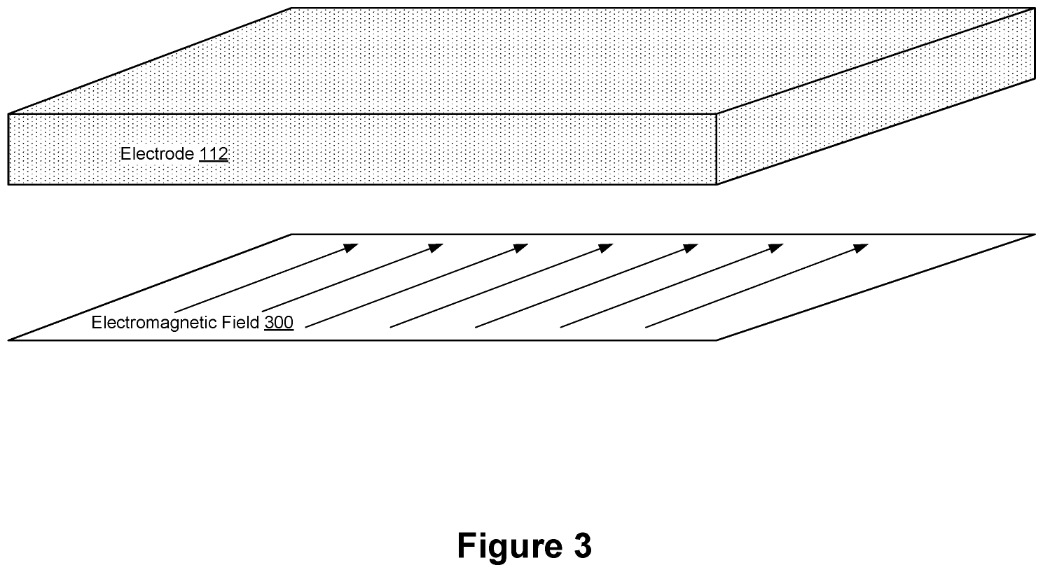

FIG. 3 is a schematic diagram illustrating an electrode 112 aligned via field induced alignment in accordance with some embodiments.

In some embodiments, the one or more electrodes are arranged via field induced alignment. In some embodiments, the field includes an electromagnetic field 300. In some configurations, the field-induced alignment facilitates formation of features aligned with the field (e.g., electromagnetic field 300). Alignment of the electrode via the field can increase the sheet resistance of the electrode 112. Increasing the sheet resistance of the one or more electrodes may reduce losses in the antenna efficiency. For example, increasing the sheet resistance of the one or more electrodes may reduce interference with wireless signals emitted and/or received by the antenna.

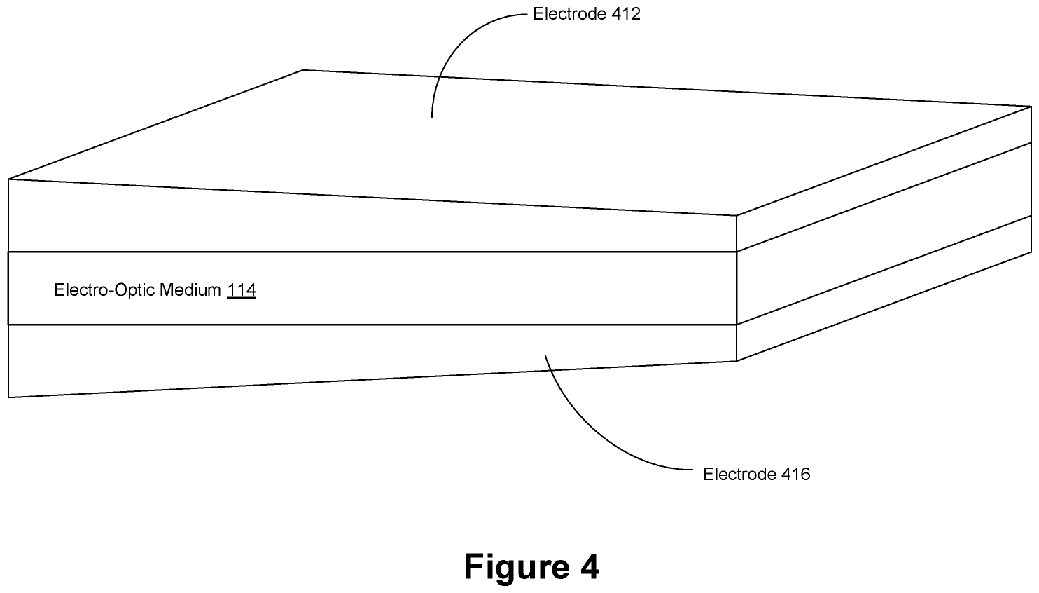

FIG. 4 is a schematic diagram illustrating an optoelectronic component with trimmed electrodes 412 and 416 in accordance with some embodiments. In some embodiments, the one or more electrodes include indium tin oxide 404.

In some embodiments, one or more electrodes (e.g., electrode 412 and/or electrode 416) are trimmed (e.g., the thickness and/or width of an electrode varies along a length of the electrode). This provides a gradual tint to the optoelectronic component. For example, in some embodiments, trimming the electrode includes selectively removing or modifying the thickness of the electrode (e.g., trimming the indium tin oxide includes selectively removing or modifying the thickness of the indium tin oxide such that a first region of the one or more optoelectronic components has less indium tin oxide than a second region of the one or more optoelectronic components).

In some embodiments, the regions with less electrode material (e.g., indium tin oxide) has increased light transmission. In some embodiments, the regions with less electrode material (e.g., indium tin oxide) has a different color (e.g., color temperature, hue, and/or saturation) compared to the regions with more electrode material (e.g., indium tin oxide). In some embodiments, the regions with more electrode material (e.g., indium tin oxide) have decreased light transmission.

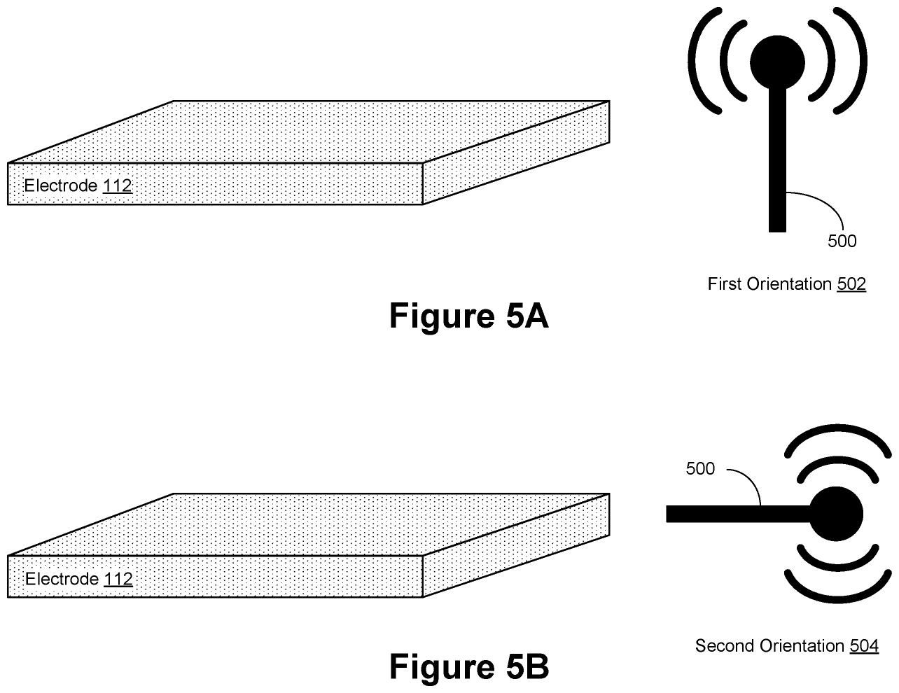

FIGS. 5A and 5B are schematic diagrams illustrating relative orientations 502, 504 of an electrode 112 and an antenna 500 in accordance with some embodiments. In some embodiments, the one or more antennas are located at a predetermined position relative to the one or more optoelectronic components (e.g., one or more electrodes). The predetermined position may include a position and/or an orientation relative to the one or more optoelectronic components.

FIG. 5A illustrates electrode 112 and antenna 500 in a first orientation 502 relative to the electrode 112 (e.g., the antenna is aligned along a direction perpendicular to a plane defined by the electrode 112). While the antenna 500 is in the first orientation 502 relative to the electrode 112, the wireless interference at the antenna 500 may be a first amount of wireless interference.

FIG. 5B illustrates electrode 112 and antenna 500 in a second orientation 504 relative to the electrode 112 (e.g., the antenna is aligned along a direction parallel to a plane defined by the electrode 112). While the antenna 500 is in the second orientation 504 relative to the electrode 112, the wireless interference at the antenna 500 may be a second amount of wireless interference.

The first amount of wireless interference may be distinct from the second amount of wireless interference. For example, when the antenna 500 is in the first orientation 502 relative to the electrode 112, the resulting first amount of wireless interference at the antenna is greater than the second amount of wireless interference when the antenna 500 is in the second orientation 504 relative to the electrode 112.

In some embodiments, the predetermined position is determined such that the wireless interference from the one or more optoelectronic components (e.g., one or more electrodes) at the antenna 500 satisfies a wireless interference threshold.

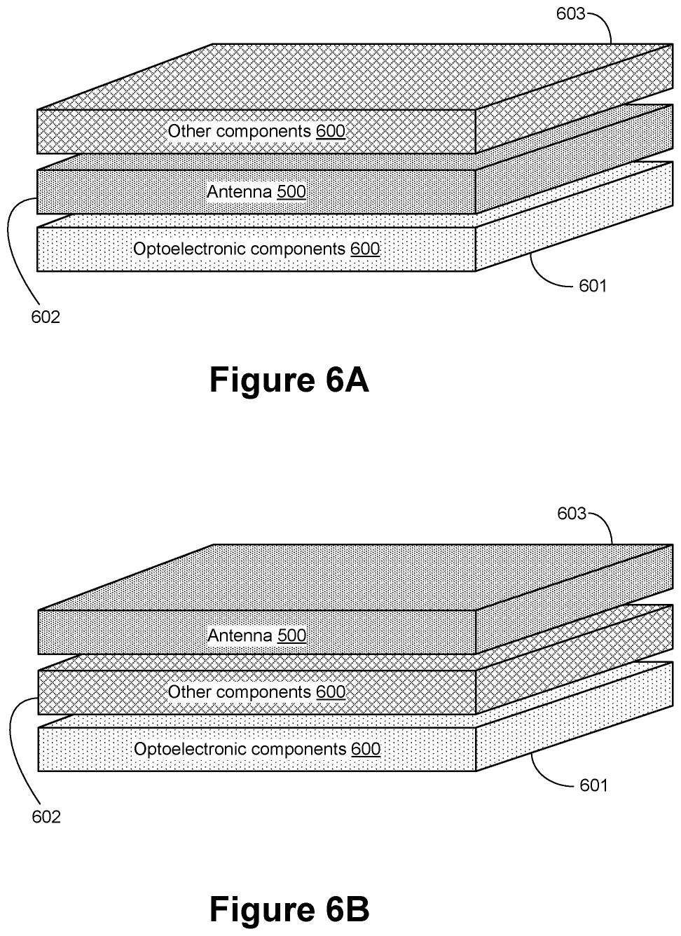

FIGS. 6A and 6B are schematic diagrams illustrating the relative positions of an electrode (in the optoelectronic components 600) and an antenna 500 in accordance with some embodiments.

FIG. 6A illustrates one or more optoelectronic components 600 in a first layer 601, one or more antennas 500 in a second layer 602 and other components 600 in a third layer 603. As shown, the first layer 601 is adjacent to the second layer 602, and the second layer 602 is adjacent to the third layer 603. The wireless interference at the one or more antennas 500 in the second layer 602 may be a third amount of wireless interference.

FIG. 6B illustrates one or more optoelectronic components 600 in a first layer 601, other components 600 in a second layer 602, and one or more antennas 500 in a third layer 603. As shown, the first layer 601 is adjacent to the second layer 602, and the second layer 602 is adjacent to the third layer 603. The wireless interference at the one or more antennas 500 in the second layer 602 may be a fourth amount of wireless interference. The separation of the one or more antennas 500 from the one or more optoelectronic components 600 may reduce the wireless interference at the one or more antennas 500.

The third amount of wireless interference may be distinct from the fourth amount of wireless interference. For example, when the one or more antennas 500 are adjacent to the one or more optoelectronic components 600 (e.g., the one or more optoelectronic components 600 are in a first layer 601 and the one or more antennas 500 are in a second layer 602 which is immediately adjacent to the first layer 601), the resulting third amount of wireless interference at the one or more antennas is greater than the fourth amount of wireless interference when the one or more antennas 500 are not adjacent to the one or more optoelectronic components 600 (e.g., the one or more optoelectronic components 600 are in a first layer 601 and the one or more antennas 500 are in a third layer 603 which is not immediately adjacent to the first layer 601).

In some embodiments, the layer positions of the one or more antennas 500 and the one or more optoelectronic components 600 are determined such that the wireless interference from the one or more optoelectronic components 600 at the one or more antennas 500 satisfies a wireless interference threshold.

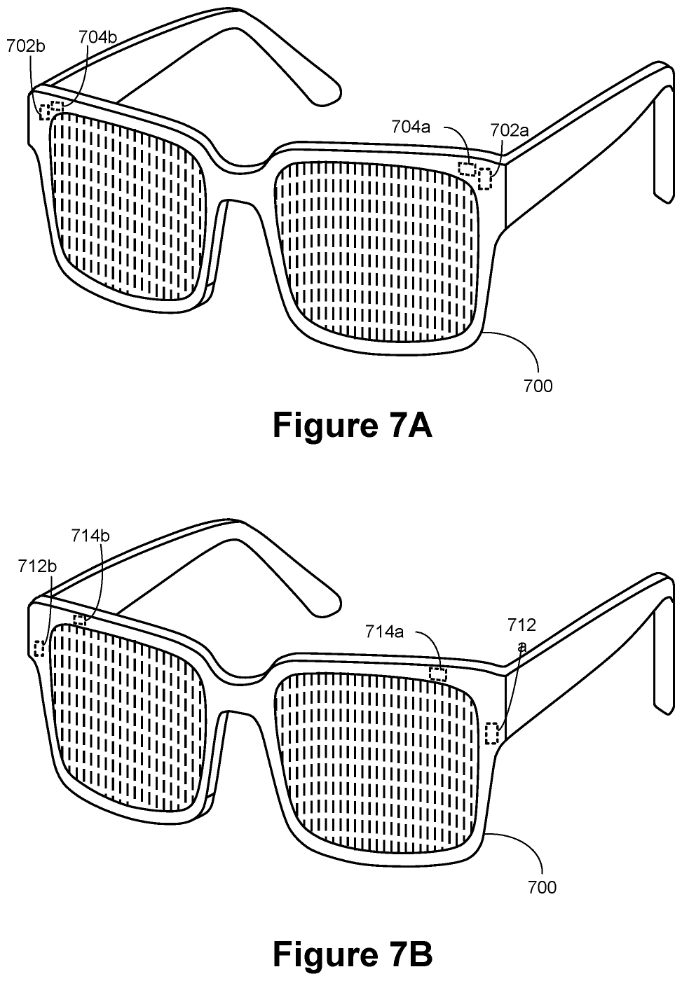

FIGS. 7A and 7B are schematic diagrams illustrating the relative positions of one or more optoelectronic components 704a, 704b, 714a, 714b, and one or more antennas 702a, 702b, 712a, 712b relative to a head-mounted display device 700 in accordance with some embodiments.

In some embodiments, the one or more optoelectronic components 704a, 704b, 714a, 714b include switchable dimming components. The one or more optoelectronic components 704a, 704b, 714a, 714b may also include a photo dichroic dichroic liquid crystal device, a two-component system (e.g., a photo dichroic liquid crystal device), and/or an electrochromic device (e.g., an electrochromic I and/or electrochromic III device).

FIG. 7A illustrates the head-mounted display device 700 with one or more optoelectronic components 704a, 704b at a first relative position to the one or more antennas 702a, 702b. While the one or more antennas 702a, 702b is in the first relative position to the one or more optoelectronic components 704a, 704b, the wireless interference at the antenna 500 may be a fifth amount of wireless interference.

FIG. 7B illustrates the head-mounted display device 710 with one or more optoelectronic components 714a, 714b at a sixth relative position to the one or more antennas 712a, 712b. The distance between the one or more antennas 712a, 712b and the one or more optoelectronic components 714a. 714b is greater in the sixth relative position than the distance between the one or more antennas 702a, 702b and the one or more optoelectronic components 704a, 704b. While the one or more antennas 712a, 712b is in the sixth relative position to the one or more optoelectronic components 714a, 714b, the wireless interference at the antenna 500 may be a sixth amount of wireless interference.

The fifth amount of wireless interference may be distinct from the sixth amount of wireless interference. For example, when the one or more antennas 702a, 702b are in the fifth relative position to the one or more optoelectronic components 704a, 704b (e.g., less distance between the antennas and the optoelectronic components), the resulting fifth amount of wireless interference at the antenna is greater than the sixth amount of wireless interference when the one or more antennas 712a, 712b are in the sixth relative position to the one or more optoelectronic components 714a. 714b (e.g., greater distance between the antennas and the optoelectronic components).

In some embodiments, the relative position is determined such that the wireless interference from the one or more optoelectronic components 704a, 704b, 714a, 714b at the one or more antennas 702a, 702b, 712a, 712b satisfies a wireless interference threshold.

In some embodiments, the head-mounted display device 700, 710 include a display that is optically coupled with the electronic device. The electronic device includes the one or more antennas 702a, 702b, 712a, 712b and the one or more optoelectronic components 704a, 704b, 714a, 714b.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Although various drawings illustrate operations of particular components or particular groups of components with respect to one eye, a person having ordinary skill in the art would understand that analogous operations can be performed with respect to the other eye or both eyes. For brevity, such details are not repeated herein.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. An electronic device, comprising:
one or more antennas; and
one or more optoelectronic components comprising one or more electrodes having a specified sheet resistance.

2. The electronic device of claim 1, wherein the one or more electrodes comprise aluminum doped zinc oxide.

3. The electronic device of claim 1, wherein the one or more electrodes comprise sub-wavelength-roughened electrodes.

4. The electronic device of claim 1, wherein the one or more electrodes comprise nano-imprinted electrodes.

5. The electronic device of claim 1, wherein the one or more electrodes comprise electroplated electrodes.

6. The electronic device of claim 1, wherein the one or more electrodes are aligned via field-induced alignment.

7. The electronic device of claim 1, wherein the one or more electrodes comprise one or more boundary layers.

8. The electronic device of claim 7, wherein the one or more boundary layers comprise one or more layers of indium molybdenum oxide.

9. The electronic device of claim 7, wherein the one or more boundary layers comprise one or more layers of indium niobium oxide.

10. The electronic device of claim 1, wherein the one or more antennas are positioned at a predetermined position relative to the one or more optoelectronic components.

11. The electronic device of claim 10, wherein the one or more antennas are positioned in a first layer of the electronic device and the one or more optoelectronic components are positioned in a second layer of the electronic device that is distinct from the first layer.

12. The electronic device of claim 1, wherein the one or more electrodes comprise indium tin oxide.

13. The electronic device of claim 12, wherein the indium tin oxide is trimmed to create a gradual tint of the one or more optoelectronic components.

14. A head-mounted display device, comprising:
an electronic device comprising:
one or more antennas; and
one or more optoelectronic components comprising one or more electrodes having a specified sheet resistance; and
a display optically coupled with the electronic device.
